(19) United States
(12) Patent Application Publication
(10) Pub. No.: US 2014/0122309 A1
(43) Pub. Date: May 1, 2014

(54) IMAGE FORMING APPARATUS, METHOD OF DRIVING THE IMAGE FORMING APPARATUS, BILLING APPARATUS, METHOD OF DRIVING THE BILLING APPARATUS, AND COMPUTER-READABLE RECORDING MEDIUM

(71) Applicant: Samsung Electronics Co., Ltd, Suwon-si (KR)

(72) Inventors: Hwan-joon CHOI, Goyang-si (KR); Jung-mo YEON, Suwon-si (KR)

(21) Appl. No.: 13/942,912

(22) Filed: Jul. 16, 2013

(30) Foreign Application Priority Data
Oct. 26, 2012 (KR) 10-2012-0119834

(51) Int. Cl. G06Q 30/04

(52) U.S. Cl. CPC G06Q 30/04
USPC 705/34

(57) ABSTRACT

An image forming apparatus, a method of driving the image forming apparatus, a billing apparatus, a method of driving the billing apparatus, and a computer-readable recording medium are provided. The image forming apparatus includes a first counter to count the number of sheets used as a job amount of an image forming job, a second counter to count the number of sheets billed as a billed amount after billing for the number of sheets used is performed, and a controller to control the billed amount to coincide with the job amount if values of the job amount and the billed amount do not coincide with each other when an event occurs.

### CROSS-REFERENCE TO RELATED APPLICATIONS

This application claims priority under 35 U.S.C. §119(a) to Korean Patent Application No. 10-2012-0119834, filed on Oct. 26, 2012, in the Korean Intellectual Property Office, the disclosure of which is incorporated herein by reference in its entirety.

### BACKGROUND OF THE INVENTION

1. Field of the Inventive Concept

The present disclosure relates generally to an image forming apparatus, a method of driving the image forming apparatus, a billing apparatus, a method of driving the billing apparatus, and a computer-readable recording medium, and more particularly, to an image forming apparatus, a method of driving the image forming apparatus, a billing apparatus, a method of driving the billing apparatus, and a computer-readable recording medium, which can increase billing accuracy in an MPS (Managed Print Service) environment in which image forming apparatuses, such as printers and multifunctional peripherals (MFPs), are managed and billed.

2. Description of the Related Art

An image forming apparatus forms an image that is printed on a printing sheet, and is implemented by, for example, an MFP having two or more functions of a printer, a copy machine, a facsimile, and the like.

Recently, a demand for an office automation device, such as an MFP that performs not only a printing function for outputting a document, but also functions of a scanner, a facsimile, and the like, has gradually been increasing. Accordingly, the image forming apparatus has currently been developed as an expensive high-performance product in order to perform various functions through an extension of the inherent performable functions.

In order to use such an expensive digital MFP, a user may purchase or rent the MFP. In the case of renting the MFP, an equipment provider may determine the used amount by performing simulations with respect sampling groups for a predetermined period before making a rental contract, and may make the rental contract in accordance with billing conditions determined in consideration of a user's printing scale and contract terms. The use charges are billed using a lump-sum billing system of costs in accordance with predetermined fixed billing conditions.

The billing system will be described in more detail. If a printer is first registered in a solution, that is, in a solution for billing, information on a used amount counter in the printer is collected. At this time, a user selects whether to prepare a bill based on the used amount counting value of “0” or the currently collected used amount. For example, if a new printer is registered in the solution, the printer is firstly used in a corresponding client company, and it is assumed that an initial counter value is “0”. In this case, even if the printer has the counting value of “1000” at the time of registration, the used amount is fixed to “1000” in the solution. By contrast, in the case of a printer which has already been used by another client company and returned and has the counting value of “1000” at the time of registration, the billing should be performed only for the used amount that is used after the counting value of “1000”. The manager performs printer registration by selecting one of two options as described above.

However, when the printer is registered in the solution as described above, only two selection items, that is, whether to prepare a bill based on the counting value of “0” or the current used amount counting value, are provided, and in the case of the printer that is moved from one client company to another client company, the used amount, which occurs before the corresponding printer is registered in the solution of the new client company, is omitted from billing.

In other words, since the removal of the printer occurs frequently in a state where the billing is not completely settled, it is not known which client company the used amount belongs to although the used amount can be collected from the corresponding printer at the time of solution registration. Although it is possible to inquire of the corresponding client company about the used amount of the printer, such inquiry may be limited from the viewpoint of the service provider since a large number of printers are handled in the rental business.

Further, during the printer registration, it is constantly necessary for the manager to determine whether a printer to be registered is a new printer. This is because it is required to determine whether the used amount, which is currently recorded in the printer to be registered, is to be billed. Due to this situation, the work efficiency is degraded.

### SUMMARY OF THE INVENTION

The present disclosure addresses at least the above problems and/or disadvantages and provides at least the advantages described below. Accordingly, the present disclosure provides an image forming apparatus, a method of driving the image forming apparatus, a billing apparatus, a method of driving the billing apparatus, and a computer-readable recording medium, which can increase billing accuracy in an MPS environment in which image forming apparatuses, such as printers and multifunctional peripherals, are managed and billed.

Additional features and utilities of the present general inventive concept will be set forth in part in the description which follows and, in part, will be obvious from the description, or may be learned by practice of the general inventive concept.

Exemplary embodiments of the present general inventive concept provide an image forming apparatus including a first counter to count the number of sheets used as a job amount of an image forming job; a second counter to count the number of sheets billed as a billed amount after billing for the number of sheets used is performed; and a controller to control the billed amount to coincide with the job amount if values of the job amount and the billed amount do not coincide with each other when an event occurs.

The image forming apparatus according to an embodiment of the present disclosure may further include a first storage to store a counting result of the first counter; and a second storage to store a counting result of the second counter.

The controller may work together with a billing apparatus that performs the billing, and the controller may operate the second counter in accordance with a command of the billing apparatus.

The controller may receive the command when the image forming apparatus is moved or returned due to occurrence of the event.

The first counter may include a plurality of counters calculating different charge amounts for the number of sheets used in accordance with at least one type of color or black/white printing, one-sided or two-sided printing, and sheet sizes, and the second counter may include a plurality of counters the number of which corresponds to the number of the counters in the first counter.

Exemplary embodiments of the present general inventive concept also provide a billing apparatus including a determiner to determine whether a job amount for the number of sheets used of an image forming job coincides with a billed amount for the number of sheets billed after billing for the number of sheets used is performed; an operator to calculate a difference value between values of the job amount and the billed amount; and a controller to control an image forming apparatus so that the billed amount coincides with the used amount if the values of the used amount and the billed amount do not coincide with each other when an event occurs.

The billing apparatus according to another embodiment of the present disclosure may further include a biller to perform the billing.

The billing apparatus according to another embodiment of the present disclosure may further include a storage acquire and store information on the job amount and the billed amount from the image forming apparatus, wherein the storage periodically updates the stored information.

The storage may store the information on a plurality of image forming apparatuses.

The billing apparatus according to another embodiment of the present disclosure may further include an interface that confirms whether the plurality of image forming apparatuses connected to a communication network have been searched for and registered.

Exemplary embodiments of the present inventive concept also provide a method of driving an image forming apparatus including counting the number of sheets used as a job amount of an image forming job at a first counter; counting the number of sheets billed as a billed amount after billing for the number of sheets used is performed at a second counter; and controlling the billed amount to coincide with the job amount if values of the job amount and the billed amount do not coincide with each other when an event occurs.

The method of driving an image forming apparatus according to still another embodiment of the present disclosure may further include storing a counting result of the first counter; and storing a counting result of the second counter.

The billing may be performed by a billing apparatus, and the second counter may perform counting in accordance with a command of the billing apparatus.

The controlling operation may receive the command when the image forming apparatus is moved or evacuated due to occurrence of the event.

Exemplary embodiments of the present inventive concept also provide a method of driving a billing apparatus including determining whether a job amount for the number of sheets used of an image forming job coincides with a billed amount for the number of sheets billed after billing for the number of sheets used is performed; calculating a difference value between values of the job amount and the billed amount; and controlling an image forming apparatus so that the billed amount coincides with the job amount if the values of the job amount and the billed amount do not coincide with each other when an event occurs.

The method of driving a billing apparatus according to still another embodiment of the present disclosure may further include performing the billing.

The method of driving a billing apparatus according to still another embodiment of the present disclosure may further include acquiring and storing information on the job amount and the billed amount from the image forming apparatus, wherein the storing operation periodically updates the stored information.

The storing operation may store the information on a plurality of image forming apparatuses.

The method of driving a billing apparatus according to still another embodiment of the present disclosure may further include confirming whether the plurality of image forming apparatuses connected to a communication network have been searched for and registered.

Exemplary embodiments of the present disclosure also provide a computer-readable recording medium including a program to execute a method of controlling an image forming apparatus, wherein the method of controlling the image forming apparatus includes receiving information on a job amount for the number of sheets used of an image forming job and a billed amount for the number of sheets billed after billing for the number of sheets used is performed when an event of the image forming apparatus occurs; determining whether values of the job amount and the billed amount coincide with each other; calculating a difference value between the values if the values of the job amount and the billed amount do not coincide with each other as the result of determination; and controlling an image forming apparatus so that the billed amount coincides with the job amount.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a diagram illustrating a billing system according to an embodiment of the present disclosure;

FIG. 2 is a diagram illustrating the configuration of the image forming apparatus of FIG. 1 according to an embodiment of the present disclosure;

FIG. 3 is a diagram illustrating the configuration of the image forming apparatus of FIG. 1 according to another embodiment of the present disclosure;

FIG. 4 is an exemplary diagram illustrating the configuration of the billing forming apparatus of FIG. 1;

FIG. 5 is a diagram illustrating a scenario in which the image forming apparatus of FIG. 1 is moved from client company A to client company B to be installed at client B;

FIG. 6 is a diagram illustrating a scenario in which the image forming apparatus of FIG. 1 is removed by the provider due to a problem;

FIG. 7 is a diagram illustrating a billing method according to an embodiment of the present disclosure;

FIG. 8 is a flowchart illustrating a method of driving an image forming apparatus according to an embodiment of the present disclosure; and

FIG. 9 is a flowchart illustrating a method of driving a billing apparatus according to an embodiment of the present disclosure.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

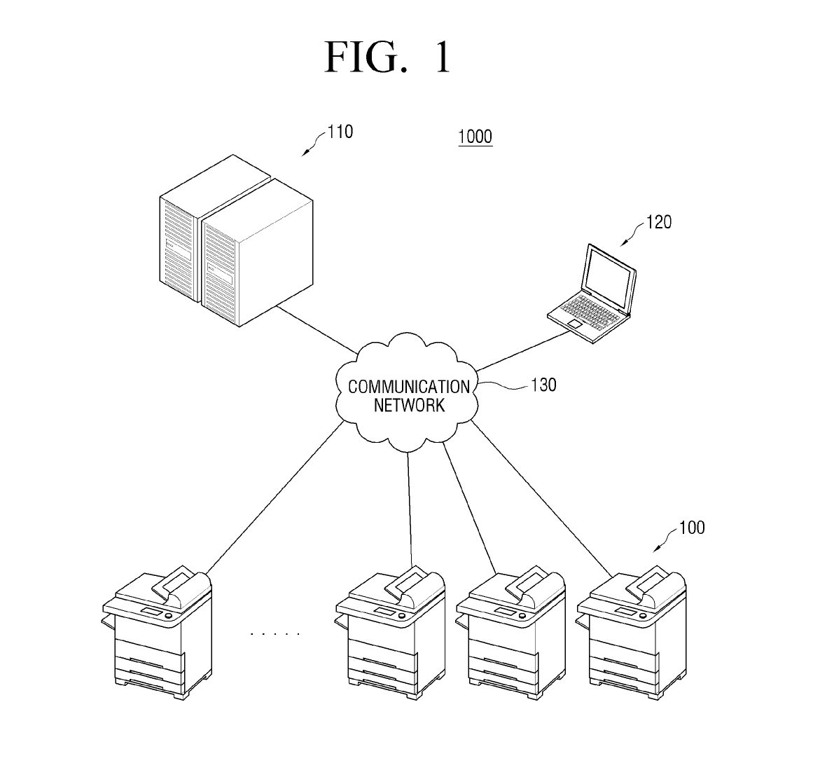

FIG. 1 is a diagram illustrating a billing system according to an embodiment of the present disclosure.

As illustrated in FIG. 1, a billing system 1000 according to an embodiment of the present disclosure includes a part or the whole of an image forming apparatus 100, a billing apparatus 110, a monitoring device 120, and a communication network 130, and may further include a host device (not illustrated) connected to the image forming apparatus 100.

Here, the term “including a part or the whole” means that a part of constituent elements, such as the billing apparatus 110 and the monitoring device, may be omitted or may be integrated with other constituent elements. For example, the monitoring device 120 may be omitted from the billing system 1000, and the function of the billing apparatus 110 may be replaced by the host device. For sufficient understanding of the present disclosure, it is assumed that all the above-described constituent elements are included in the system.

The image forming apparatus 100 may be implemented, for example, as a printer, a copy machine, a facsimile, a scanner, or a multifunction peripheral (MFP) in which functions of the above-described devices are multiply implemented into one device. The image forming apparatus 100 according to an embodiment of the present disclosure may be usefully used in an MPS environment in which a rental provider purchases a large number of image forming apparatuses 100, rents the image forming apparatuses 100 to client companies, and manages and bills for the rental image forming apparatuses. In the MPS environment, removal and installation, and evacuation of the image forming apparatuses occur frequently due to problems with the image forming apparatuses or rental contract changes. In this case, for example, if an image forming apparatus 100, which has been used in one client company, is removed (evacuated) and re-rented to another client company, it is important to collect data and bill accurately for the used amount of the image forming apparatus 100 used by the new client company.

In order to perform an accurate billing, the image forming apparatus 100 internally has information on a job amount of an image forming job, that is, the number of sheets used as the used amount of the sheets, and a billed amount, that is, the number of sheets billed indicating whether the billing has been performed for the number of sheets used as the billed amount. Here, the job amount and the billed amount may be stored, for example, as the counting result by a counter. In this case, the image forming apparatus 100 may be provided with a plurality of counters for different billings in accordance with color or black/white printing, one-sided or two-sided printing, and sheet sizes.

Thereafter, if a newly installed image forming apparatus 100 is searched for and registered through the MPS, and there is a request for information on the used amount of the image forming apparatus 100 and the billed amount according to the used amount, the image forming apparatus 100 provides the corresponding information to the billing apparatus 110. If there is a difference between values of the used amount and the billed amount as the result of comparison by the billing apparatus 100, the image forming apparatus 100 makes the values of the used amount and the billed amount coincide with each other in accordance with an instruction of the billing apparatus 110. This operation to make the values of the used amount and the billed amount coincide with each other may be performed after the billing is actually performed, but is not limited thereto. For example, the operation to make the values of the used amount and the billed amount coincide with each other may be performed when the rental contract is changed or canceled according to an embodiment of the present disclosure. In other words, the change corresponds to a case where the image forming apparatus 100 is moved from client company A to client company B, and the cancellation means the removal (evacuation) of the image forming apparatus 100. In an embodiment of the present disclosure, the moving or removal (evacuation) of the image forming apparatus 100 is considered as the occurrence of an event.

As described above, in the case where the image forming apparatus 100 is moved to another client company or is removed (evacuated) and returned to the rental provider, the image forming apparatus internally makes the values of the used amount and the billed amount coincide with each other and stores the result. Accordingly, if the values of the billed amount and the used amount do not coincide with each other after the image forming apparatus 100 is moved and installed, it becomes clear that the client who has newly installed the image forming apparatus 100 has used the image forming apparatus 100 for only the difference value. Accordingly, the billing basis becomes clear. Further, a separate process of determining whether the image forming apparatus 100 is a newly registered image forming apparatus becomes unnecessary.

The billing apparatus 110 includes, for example, a server or a computer, and may further include or interwork with a database. The billing apparatus 110 requests information on the used amount of the image forming job and the billed amount from the image forming apparatus 100, and thereafter bills for the difference value obtained by comparing the used amount and the billed amount with each other, which are provided from the image forming apparatus 100. If the difference value is included for the billing, the billing apparatus 110 instructs the image forming apparatus 100 again to adjust the billed amount information so that the billed amount coincides with the used amount. In this process, the billing apparatus 110 may perform a process of searching for and registering a newly introduced image forming apparatus 100 before requesting the information, and thus can request the information only with respect to the registered image forming apparatuses 100.

The monitoring device 120 periodically monitors the billing apparatus 110. In other words, the monitoring device 120 confirms the used amount and the billed amount with respect to a plurality of image forming apparatuses 100 connected to the billing apparatus 110. In this process, if some of the image forming apparatuses 100 are removed from a client company and delivered to a new client company, the monitoring device 120 may instruct the billing depending on whether the used amount of the image forming job used by the corresponding client company coincides with the billed amount. Further, in the case where the image forming apparatus 100 is newly registered and used, the monitoring device 120 can instruct the billing through an accurate determination of the used amount used by the new client company thereafter based on the billed amount information even with respect to the used amount that is used without any separate registration process.

The communication network 130 includes all wired/wireless communication networks. Here, the wired network may include the Internet, such as a cable network or a public telephone network PSTN, and the wireless communication network may include CDMA, WCDMA, GSM, EPC (Evolved Packet Core), LTE (Long Term Evolution), and WiBro network. For example, if the communication network 130 is a wireless communication network, the image forming apparatus 100 may connect to SGSN or GGSN (Gateway GPRS Support Node) that is operated by a communication company to process data, or may connect to various repeaters, such as BTS (Base Station Transmission), NodeB, and 3-NodeB to process data.

Although not separately illustrated in the drawing, a host device connected to other image forming apparatuses 100 may include devices, such as a portable phone, a notebook computer, and a desk top computer. These devices may instruct the image forming job to the image forming apparatus 100, and may further substitute for the function of the billing apparatus 110 according to an embodiment of the present disclosure. Accordingly, in an embodiment of the present disclosure, the functions of the host device are not specifically limited to the above-described functions.

In an embodiment of the present disclosure, the MPS records the billed amount and the used amount in the image forming apparatus 100, and thus the MPS can be operated without an error, such as duplicate billing or erroneous non-billing.

Further, when a manager registers the image forming apparatus 100 by executing a program in the billing apparatus 110, new equipment is automatically determined even without selecting the new equipment, and thus the billing can automatically start without selection of the manager.

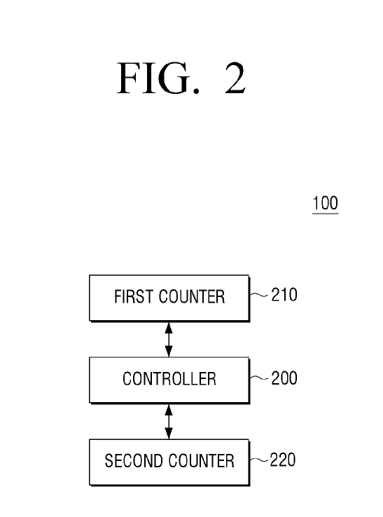

FIG. 2 is a diagram illustrating the configuration of the image forming apparatus of FIG. 1 according to an embodiment of the present disclosure.

Referring to FIG. 2 together with FIG. 1, the image forming apparatus 100 according to an embodiment of the present disclosure includes a part or the whole of a controller 200, a first counter 210, and a second counter 220, and may further include an image former and an interface.

Here, the term “including a part or the whole” means that the first counter 210 and the second counter 220 may be integrally configured, and in this case, they may be implemented by one program. For sufficient understanding of the present disclosure, description will be made on the assumption that the whole constituent elements are included in the image forming apparatus 100.

The controller 200 serves to control the first counter 210 and the second counter 220 in the image forming apparatus 100. More specifically, the controller 200 may interwork with the billing apparatus 110 of FIG. 1 through the interface. The controller 200 may provide value information of the used amount and the billed amount stored in the first counter 210 and the second counter 220, respectively, and adjust the billed amount information of the second counter 220 according to a command, that is, may increase the number of sheets.

The first counter 210 counts the used amount for an image forming job of the image forming apparatus 100 in accordance with a user's request. For this, the first counter 210 may interwork with the image former. Here, the term “counting” may be used to include all of expressing a counting value using a counter according to an embodiment of the present disclosure, storing and operating the corresponding information. Accordingly, the first counter 210 may include counters counting the used amount and a storage storing counted information, for example, in a lookup table (LUT) form.

Further, the first counter 210 may include a plurality of counters. The plurality of counters are to perform different billings depending on color or black/white printing, one-sided or two-sided printing, and sheet sizes. For example, the first counter 210 may be divided into a counter that can perform counting when a color sheet is printed and a counter that can perform counting when a black/white sheet is printed.

The second counter 220 may adjust the billed amount under the control of the controller 200. For example, if the used amount of the image forming job is calculated as “50” in the first counter 210, and the billing is performed for the corresponding used amount in the unit of the number of sheets, the second counter 220 may adjust the counting value by making the used amounts coincide with each other, and may store the information on the number of sheets billed. For this, the second counter 220 may include counters and a storage storing the information counted through the counters.

In an embodiment of the present disclosure, in order to discriminate from the counters and the storage of the first counter, the counters and the storage of the second counter 220 may be called second counters and the second storage, and the first storage of the first counter 210 and the second storage of the second counter 220 may be integrally formed with each other to provide one storage. Accordingly, in an embodiment of the present disclosure, the configuration of the storage is not specially limited.

In the same manner as the first counter 210, the second counter 220 may include a plurality of counters. In this case, it is preferable that the number of counters in the first counter is the same as the number of counters in the second counter. For example, if the first counter 210 has two counters to perform different counting operations depending on whether the sheet is a color sheet, the second counter 220 also has two counters to correspond to the counters of the first counter 210.

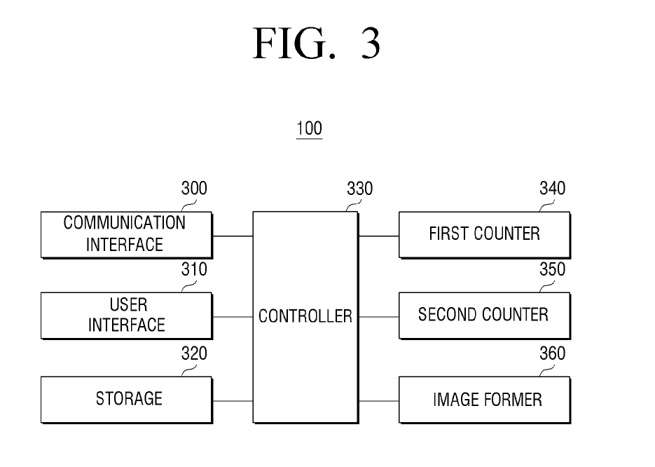

FIG. 3 is a diagram illustrating the configuration of the image forming apparatus of FIG. 1 according to another embodiment of the present disclosure.

Referring to FIG. 3 together with FIG. 1, the image forming apparatus 100 according to another embodiment of the present disclosure includes a part or the whole of a communication interface 300, a user interface 310, s storage 320, a controller 330, a first counter 340, a second counter 350, and an image former 360. Here, the term “including a part or the whole” has the same meaning as that as described above.

The communication interface 300 corresponds to the configuration for performing communication with the billing apparatus 110. For example, the communication interface 300 may receive a request message from the billing apparatus 110, which requests information on the used amount for the image forming job and the billed amount in the image forming apparatus 100, and may also receive a message to instruct an adjustment of the billed amount information if such an adjustment of the billed amount information of the image forming apparatus 100 is necessary depending on the billing performance. Further, if related information is received in the form of a message, the communication interface 300 may additionally perform a process of analyzing the related information.

Further, the communication interface 300 may include a short-distance communication module. For this, the communication interface 300 may perform short-distance communication with the host device, such as a portable phone, and thus may provide for print data received from the host device be printed through the image former 360.

The user interface 310 includes a button or a touch type display to input user information or to confirm the information stored in the image forming apparatus 100. For example, if the user intends to confirm the used amount information and the billed amount information stored in the image forming apparatus 100 through the button of the image forming apparatus 100, the user interface 310 may display the corresponding information through the display.

The storage 320 may receive the print data provided from the host device through the communication interface 300, temporarily store and then output the print data to the image former 360 under the control of the controller 330, and store scan data scanned through the scanning function of the image former 360. Thereafter, the storage 320 may output the scan data to the display of the user interface 310 in accordance with the user request. Further, in the case where the first counter 340 and the second counter 350 do not include a separate storage, the storage 320 may store the used amount and billed amount information of the first counter 340 and the second counter 350. In this case, the stored billed amount information is periodically updated in accordance with the instruction of the billing apparatus 110.

According to an embodiment of the present disclosure, the storage 320 may store the used amount and billed amount information through classification of the job as in Table 1. In Table 1, it is exemplified that the sheet sizes are limited to A4 and A3. However, in practice, information can be stored in the form of a lookup table with respect to all sheet sizes.

TABLE 1

| | Color | | | | | | | | Black/White | | | | | | | |
|---|---|---|---|---|---|---|---|---|---|---|---|---|---|---|---|---|
| | One-sided | | | | Two-sided | | | | One-sided | | | | Two-sided | | | |
| Job Type | A4 | | A3 | | A4 | | A3 | | A4 | | A3 | | A4 | | A3 | |
| Print | C | B | C | B | C | B | C | B | C | B | C | B | C | B | C | B |
| Copy | C | B | C | B | C | B | C | B | C | B | C | B | C | B | C | B |
| Faxin | C | B | C | B | C | B | C | B | C | B | C | B | C | B | C | B |
| Faxout | C | B | C | B | C | B | C | B | C | B | C | B | C | B | C | B |
| Scan | C | B | C | B | C | B | C | B | C | B | C | B | C | B | C | B |
| Report | C | B | C | B | C | B | C | B | C | B | C | B | C | B | C | B |

The image former 360 performs functions of printing and scanning. For example, the image former 360 includes a print engine, and can print the print data provided from the host device. That is, the image former 360 outputs the print data as prints. Further, the image former 360 can form scan data by scanning the input prints.

Since the controller 330, the first count 340, and the second counter 350 are not so different from the controller 200, the first counter 210, and the second counter 220, respectively, in FIG. 2, further description thereof will be omitted.

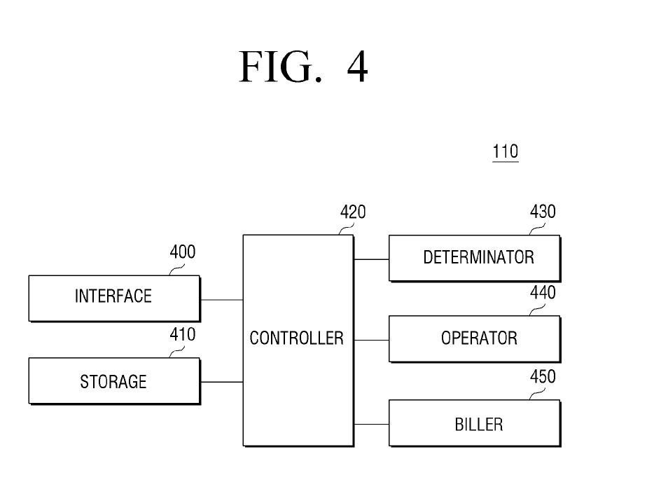

FIG. 4 is an exemplary diagram illustrating the configuration of the billing forming apparatus of FIG. 1.

Referring to FIG. 4 together with FIG. 1, the billing apparatus 110 according to an embodiment of the present disclosure includes a part or the whole of an interface 400, a storage 410, a controller 420, a determiner 430, an operator 440, and a biller 450.

Here, the term “including a part or the whole” means that some constituent elements, such as the determiner 430 and the operator 440, may be integrally configured with other constituent elements, such as the biller 450, and may be implemented by one program. For sufficient understanding of the present disclosure, description will be made on the assumption that the whole constituent elements are included in the billing apparatus 110.

The interface 400 is, for example, a communication interface, and corresponds to a constituent element that performs communication with the image forming apparatus 100 and the monitoring device 120. The interface 400 may additionally perform conversion of the information in the communication process.

The storage 410 may include a database. The storage 410 stores the information processed by the billing apparatus 110 under the control of the controller 420. For example, the storage 410 may store the result of operation or the result of billing performed by the billing apparatus 110. If the billing apparatus 110 has a separate database connected to an outside, the billing apparatus 110 may store the simple processing result in the storage 410, and may store the billing result for a plurality of image forming apparatuses 100 in the separate database.

The controller 420 serves to generally control the interface 400, the storage 410, the determiner 430, the operator 440, and the biller 450 in the billing apparatus 110. For example, the controller 420 may request the used amount information of the image forming job and the billed amount information which are stored in the image forming apparatus 100. Further, if an event occurs as the result of determination in the determiner 430, the controller 420 controls to adjust the billed amount of the image forming apparatus 100 by the difference value calculated by the calculator 440. The adjusted information may be stored in the storage 410.

If an event, such as removal (evacuating) or moving of the image forming apparatus 100, occurs, the determiner 430 may determine whether values of the used amount for the image forming job and the billed amount coincide with each other using the used amount and billed amount information provided from the image forming apparatus 100 according to the request. Such a determination process may be performed when an event, such as rental contract change and cancellation of the image forming apparatus 100, occurs actually.

The operator 440 notifies the controller 420 of the amount value information if it is determined that the values do not coincide with each other as the result of determination by the determiner 430. In other words, if the values do not coincide with each other, the operator 440 may calculate the difference value. At this time, since the billed amount does not exceed the used amount, the difference value between the used amount and the billed amount is calculated based on the billed amount. The result of the calculation may be provided to the controller 420 and the biller 450.

The biller 450 performs billing for the difference value. In other words, in the case where the printing is performed as the image forming job, the operator 440 calculates the number of printed sheets, and the biller 450 estimates the amount of money for the number of printed sheets.

On the other hand, in an embodiment of the present disclosure, the billing apparatus 110 includes the determiner 430, the operator 440, and the biller 450, which are separated from one another. However, the billing apparatus 110 may be implemented by one program, in which the determiner 430, the operator 440, and the biller 450 are integrally formed, stored in a recording medium. Accordingly, the configuration of the billing apparatus 110 is not specially limited to that as described above.

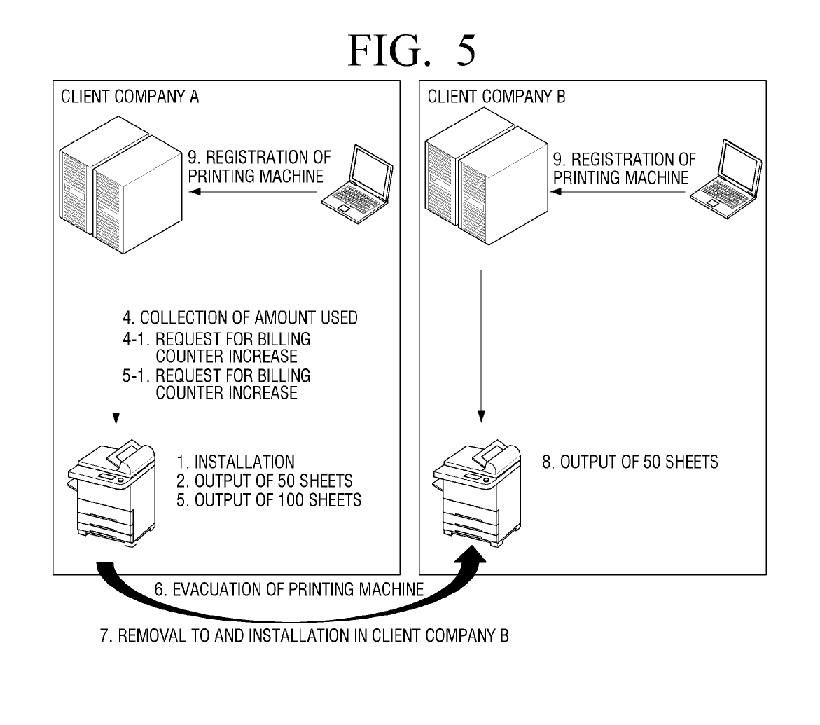

FIG. 5 is a diagram illustrating a scenario in which the image forming apparatus of FIG. 1 is moved from client company A to client company B to be installed at client B. In FIG. 5, it is exemplified that the image forming apparatus 100 of FIG. 1 is a printer.

FIG. 5 is prepared based on the scenario in which one printer is moved from client company A to client company B to be installed in a real use environment, and Table 2 shows the changes of the information of the used amount and the billed amount depending on the order of events.

TABLE 2

| | Used | | Expected |
|---|---|---|---|
| | amount | Billing | accumulated |
| Event | counter | counter | billing |
| 1. Printer rental provider purchases and rents a printer to client | 0 | 0 | 0 |
| company A. | | | |
| 2. Client company A outputs 50 sheets before registering the printer in | 50 | 0 | 0 |
| the solution. | | | |
| 3. Manager of client company A registers the printer in the | 50 | 0 | 0 |
| solution. | | | |
| Billing starts from 0 sheet since the printer is initially | | | |
| introduced. | | | |
| 4. Collect counting value and start billing with respect to client | 50 | 0 | 50 |
| company A. | | | |
| 4-1. Include the difference value between the used amount counting | 50 | 50 | 50 |
| value and the billed amount counting value in billing and request | | | |
| increase of billed amount counting value of the corresponding | | | |
| counter. | | | |
| 5. Client company A outputs 100 sheets. | 150 | 50 | 50 |
| 5-1. Include the difference value between the used amount counting | 150 | 150 | 150 |
| value and the billed amount counting value in billing and request | | | |
| increase of billed amount counting value of the corresponding | | | |
| counter. | | | |
| 6. Evacuate the printer from client company A due to trouble - Install | 150 | 150 | 150 |
| new replacement equipment. | | | |
| 7. Rental provider repairs and rents the corresponding printer to client | 150 | 150 | 150 |
| company B. | | | |
| 8. Client company B outputs 50 sheets before registering the printer in | 200 | 150 | 150 |
| the solution. | | | |
| 9. Manager of client company B registers the printer in the | 200 | 200 | 200 |
| solution. | | | |
| The solution automatically select to bill from 50 sheets except for | | | |
| 150 sheets billed for with respect to another client company of the | | | |
| corresponding printer. | | | |

As can be seen at item no. 6 in Table 2, it is exemplified that the printer in trouble is removed (evacuated) from client company A, is repaired, and then is rented to client company B. At this time, the used amount counting value and the billed amount counting value coincide with each other.

As a result, the billing apparatus 110 of FIG. 1 can accurately determine the used amount used before registration of the newly rented printer in client company B based on the billed amount information. Even if only the used amount information is provided, the problem that it is not possible to accurately determine whether previous client company A or new client company B has used the printer for the used amount can be solved.

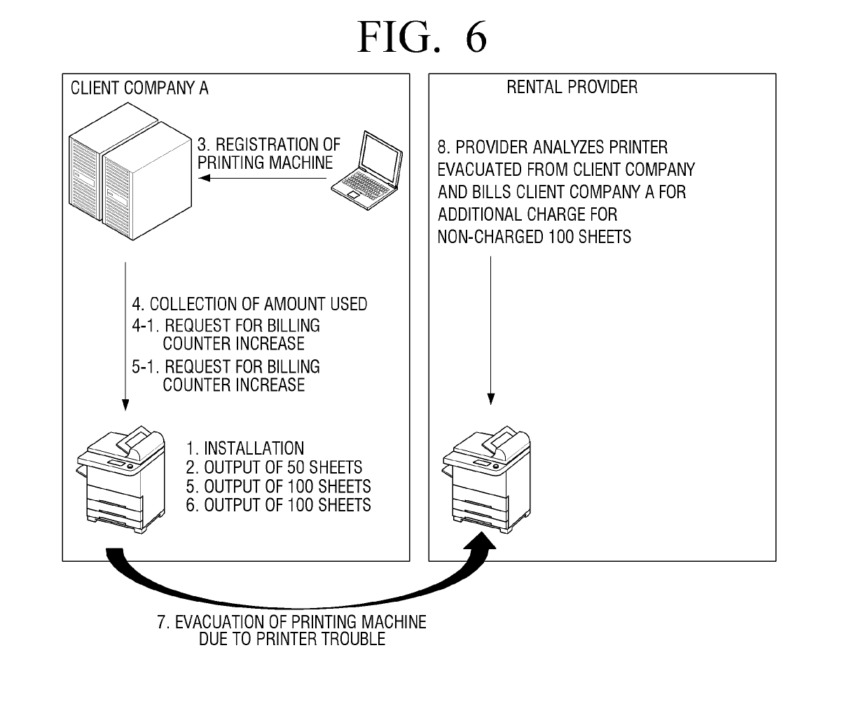

FIG. 6 is a diagram illustrating a scenario in which the image forming apparatus of FIG. 1 is removed by the provider due to a problem. In FIG. 6, it is exemplified that the image forming apparatus 100 of FIG. 1 is a printer as described above.

In the case where the printer is removed by the rental provider due to a problem rather than moved to another client company, as illustrated in FIG. 6, the counter provided in the printer itself is analyzed, and the basis of additional billing for the non-billed 100 sheets can be presented.

TABLE 3

| | Used | | Expected |
|---|---|---|---|
| | amount | Billing | accumulated |
| Event | counter | counter | billing |
| 1. Printer rental provider purchases and rents a printer to client | 0 | 0 | 0 |
| company A. | | | |
| 2. Client company A outputs 50 sheets before registering the printer in | 50 | 0 | 0 |
| the solution. | | | |
| 3. Manager of client company A registers the printer in the | | | |
| solution. | 50 | 0 | 0 |
| Billing starts from 0 sheet since the printer is initially | | | |
| introduced. | | | |
| 4. Collect counting value and start billing with respect to client | 50 | 0 | 50 |
| company A. | | | |
| 4-1. Include the difference value between the used amount counting | | | |
| value and the billed amount counting value in billing and request | 50 | 50 | 50 |
| increase of billed amount counting value of the corresponding | | | |
| counter. | | | |
| 5. Client company A outputs 100 sheets. | 150 | 50 | 50 |
| 5-1. Include the difference value between the used amount counting | | | |
| value and the billed amount counting value in billing and request | 150 | 150 | 150 |
| increase of billed amount counting value of the corresponding | | | |
| counter. | | | |
| 6. Client company A outputs 100 sheets. | 250 | 150 | 150 |
| 7. Evacuate the printer from client company A due to trouble. | 250 | 150 | 150 |
| 8. Printer rental provider analyzes evacuated printer and | | | |
| performs billing for non-billed 100 sheets with respect to the | | | |
| corresponding client company | 250 | 150 | 150 |
| * Make the billed amount counting value coincide with the used | | | |
| amount counting value and ship the corresponding printer for re- | | | |
| rental. | | | |

For example, as can be seen at item no. 7 in Table 3, in the case of removing the printer from client company A due to printer problems, the printer rental provider verifies again the used amount counting value and the billed amount counting value as described at item no. 8. At this time, if the used amount counting value is larger than the billed amount counting value, it can be recognized that there are non-billed 100 sheets, and the rental provider may perform additional billing with respect to the corresponding client company A. As a result, it is possible to perform accurate billing.

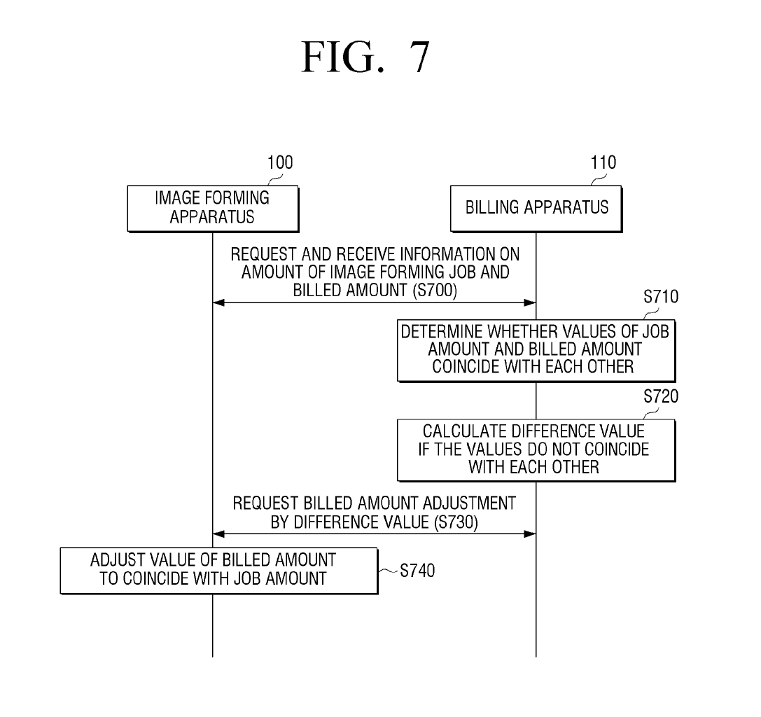

FIG. 7 is a diagram illustrating a billing method according to an embodiment of the present disclosure.

Referring to FIG. 7 together with FIG. 1 for convenience in explanation, the billing apparatus 110 according to an embodiment of the present disclosure requests the used amount for the image forming job, that is, the job amount and billed amount information from the image forming apparatus 100, and receives the requested information (operation S700).

Then, the billing apparatus 110 determines whether the values of the job amount and the billed amount coincide with each other by comparing the job amount with the billed amount (operation S710).

As the result of the determination, if they do not coincide with each other, the billing apparatus 110 calculates the difference value, and provides the result of the calculation to the image forming apparatus 100 to command the image forming apparatus 100 to adjust the billed amount information (operation S720).

Thereafter, the image forming apparatus 100 adjusts the billed amount value so that the billed amount value stored therein coincides with the used amount, that is, the job amount, in accordance with the command of the billing apparatus 110 (operation S740).

It is preferable that the above-described process is performed when an event occurs, in which the image forming apparatus 100 is newly registered by the rental provider or the image forming apparatus 100 is moved after being used by another client company. Since the billing is performed based on the job amount for the image forming job and the billed amount, which have been adjusted to coincide with each other and stored in the image forming apparatus 100, the billing basis becomes clear to that extent.

More specifically, the operation of the configuration will be described on the assumption that the image forming device 100 is a printer and the printer includes the used amount counter and the billing counter.

If the newly installed printer is searched for and registered through the MPS, counting information of the used amount counter and the billing counter of the corresponding printer is collected. If the used amount counting value is equal to the billed amount counting value, the billing starts from the used amount of “0”. Typically, at an initial shipment of the printer, the values are all “0”. If the used amount occurs during periodical monitoring of the used amount counting value, the used amount of the printer is increased, but the billed amount is not changed. If the used amount of 10 sheets occurs, this is successfully collected through the MPS, and in order to bill for this, the MPS request an SNMP set for increasing the billed amount counting value of the corresponding printer by 10 from the printer. In this case, both the used amount counting value and the billed amount counting value are increased by 10. That is, the used amount counting value that is included in the current used amount counting value to be billed for is stored in the printer. Thereafter, if the corresponding printer is evacuated and delivered to a new place, the corresponding printer is not registered in the MPS, and even if 10 sheets are used, the billing is performed accurately for the value occurring after the use of 10 sheets based on the existing billed amount counting value.

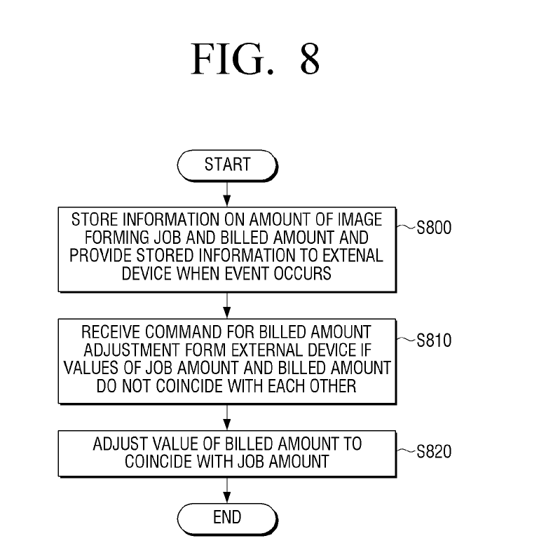

FIG. 8 is a flowchart illustrating a method of driving an image forming apparatus according to an embodiment of the present disclosure.

Referring to FIG. 8 together with FIG. 1, the image forming apparatus 100 according to an embodiment of the present disclosure stores information on the job amount for the image forming job and the billed amount for the job amount, and when an event occurs, provides the stored information in accordance with a request of an external device such as the billing apparatus 110 (operation S800). Here, the term “event occurrence” may mean the moving and removal of the image forming apparatus 100 that has been rented and used.

Further, if it is determined that the values of the job amount and the billed amount do not coincide with each other as the result of determination by the external device, the image forming apparatus 100 receives a command to adjust the billed amount from the external device (operation S810). In this case, the command for the adjustment may include difference value information between the job amount and the billed amount based on the billed amount.

Thereafter, the image forming apparatus 100 adjusts the billed amount value information so that the values of the job amount, that is, the used amount, and the billed amount coincide with each other (operation S820).

When the event occurs, the image forming apparatus 100 makes the used amount and the billed amount coincide with each other and stores them therein, and thus an accurate basis for the rental provider to bill for the used amount to the client company can be provided even in the case of moving and evacuating the image forming apparatus 100.

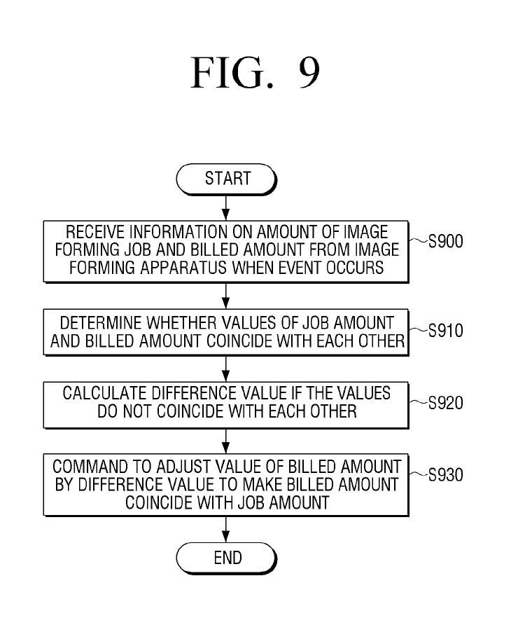

FIG. 9 is a flowchart illustrating a method of driving a billing apparatus according to an embodiment of the present disclosure.

Referring to FIG. 9 together with FIG. 1, when the event occurs, the billing apparatus 110 according to an embodiment of the present disclosure receives the information on the job amount of the image forming job and the billed amount for the job amount from the image forming apparatus 100 (operation S900). The information may be provided in accordance with the request of the billing apparatus 110 or may be provided when the image forming apparatus 100 automatically determines the event occurrence.

Then, the billing apparatus 110 determines whether the values of the received job amount and the billed amount coincide with each other (operation S910). For this, the billing apparatus 110 may include a comparator.

If the values do not coincide with each other as the result of the determination, the billing apparatus 110 may calculate the difference value (operation S920).

Thereafter, the billing apparatus 110 commands the image forming apparatus to adjust the billed amount value by the difference value so that the billed amount value coincides with the job amount value (operation S930).

As described above, when an event occurs, the billing apparatus 110 makes the used amount and the billed amount of the image forming apparatus 100 coincide with each other, and thus can perform accurate billing for the used amount with respect to a new client company.

On the other hand, according to the exemplary embodiments of the present disclosure, all the constituent elements are combined into one constituent element to operate as the combined constituent element. However, the present disclosure is not limited to the described exemplary embodiments. That is, within the purpose range of the present disclosure, one or more of all the constituent elements may be selectively combined and operated. Further, although all the constituent elements are described as being implemented by independent hardware, they may be implemented as a computer program having program modules which perform partial or whole functions that are obtained by selectively combining a part or the whole of the constituent elements or by combining one or plural pieces of hardware. Codes and code segments that constitute the computer program may be easily inferred by those skilled in the art to which the present disclosure pertains. The computer program is stored in a computer-readable media and read and executed by a computer to implement the embodiments of the present disclosure. The media storing the computer program may include a magnetic recording media, optical recording media, and carrier wave media.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a first counter to count the number of sheets used as a job amount of an image forming job;
a second counter to count the number of sheets billed as a billed amount after billing for the number of sheets used is performed; and
a controller to control the billed amount to coincide with the job amount if values of the job amount and the billed amount do not coincide with each other when an event occurs.

2. The image forming apparatus as claimed in claim 1, further comprising:
a first storage to store a counting result of the first counter; and
a second storage to store a counting result of the second counter.

3. The image forming apparatus as claimed in claim 1, wherein the controller interworks with a billing apparatus that performs the billing, and
the controller operates the second counter in accordance with a command of the billing apparatus.

4. The image forming apparatus as claimed in claim 3, wherein the controller receives the command when the image forming apparatus is moved or removed as occurrence of the event.

5. The image forming apparatus as claimed in claim 1, wherein the first counter includes a plurality of counters calculating different charge amounts for the number of sheets used in accordance with at least one type of color or black and white printing, one-sided or two-sided printing, and sheet sizes, and
the second counter includes a plurality of counters the number of which corresponds to the number of the counters in the first counter.

6. A billing apparatus comprising:
a determiner to determine whether a job amount for the number of sheets used of an image forming job coincides with a billed amount for the number of sheets billed after billing for the number of sheets used is performed;
an operator to calculate a difference value between values of the job amount and the billed amount; and
a controller to control an image forming apparatus so that the billed amount coincides with the job amount if the values of the job amount and the billed amount do not coincide with each other when an event occurs.

7. The billing apparatus as claimed in claim 6, further comprising:
a biller to perform the billing.

8. The billing apparatus as claimed in claim 6, further comprising:
a storage to acquire and store information on the job amount and the billed amount from the image forming apparatus,
wherein the storage periodically updates the stored information.

9. The billing apparatus as claimed in claim 8, wherein the storage stores the information related to a plurality of image forming apparatuses.

10. The billing apparatus as claimed in claim 6, further comprising:
an interface to confirm whether the plurality of image forming apparatuses connected to a communication network have been searched for and registered.

11. A method of driving an image forming apparatus, the method comprising:
counting the number of sheets used as a job amount of an image forming job, by a first counter;
counting the number of sheets billed as a billed amount after billing for the number of sheets jobbed is performed, by a second counter; and
controlling the billed amount to coincide with the job amount if values of the job amount and the billed amount do not coincide with each other when an event occurs.

12. The method of driving an image forming apparatus as claimed in claim 11, further comprising:
storing a counting result of the first counter; and
storing a counting result of the second counter.

13. The method of driving an image forming apparatus as claimed in claim 11, wherein the billing is performed by a billing apparatus, and
the second counter performs counting in accordance with a command of the billing apparatus.

14. The method of driving an image forming apparatus as claimed in claim 13, wherein the controlling operation receives the command when the image forming apparatus is moved or removed as occurrence of the event.

15. A method of driving a billing apparatus, the method comprising:
determining whether a job amount for the number of sheets used of an image forming job coincides with a billed amount for the number of sheets billed after billing for the number of sheets jobbed is performed;
calculating a difference value between values of the job amount and the billed amount; and
controlling an image forming apparatus so that the billed amount coincides with the job amount if the values of the job amount and the billed amount do not coincide with each other when an event occurs.

16. The method of driving a billing apparatus as claimed in claim 15, further comprising:
performing the billing.

17. The method of driving a billing apparatus as claimed in claim 15, further comprising:
acquiring and storing information on the job amount and the billed amount from the image forming apparatus,
wherein the storing operation periodically updates the stored information.

18. The method of driving a billing apparatus as claimed in claim 17, wherein the storing operation stores the information related to a plurality of image forming apparatuses.

19. The method of driving a billing apparatus as claimed in claim 15, further comprising:
confirming whether the plurality of image forming apparatuses connected to a communication network have been searched for and registered.

20. A computer-readable recording medium including a program to execute a method of controlling an image forming apparatus, wherein the method of controlling the image forming apparatus comprises:
receiving information on a job amount for the number of sheets used of an image forming job and a billed amount for the number of sheets billed after billing for the number of sheets used is performed when an event of the image forming apparatus occurs;
determining whether values of the job amount and the billed amount coincide with each other;
calculating a difference value between the values if the values of the job amount and the billed amount do not coincide with each other as the result of determination; and
controlling an image forming apparatus so that the billed amount coincides with the job amount.
